(19) United States
(12) Patent Application Publication
(10) Pub. No.: US 2025/0364904 A1
(43) Pub. Date: Nov. 27, 2025

(54) SWITCHING CONVERTER WITH PRE-CHARGE CIRCUIT

(71) Applicant: Chengdu Monolithic Power Systems Co., Ltd., Chengdu (CN)

(72) Inventors: Xu Han, Hangzhou (CN); Ting Ge, San Jose, CA (US); Alexis Penamora, Morgan Hill, CA (US); Daocheng Huang, San Jose, CA (US)

(21) Appl. No.: 19/218,075

(22) Filed: May 23, 2025

(30) Foreign Application Priority Data
May 27, 2024 (CN) CN202410666746.X

(51) Int. Cl. H02M 1/36; H02M 3/07

(52) U.S. Cl. CPC H02M 1/36; H02M 3/07

(57) ABSTRACT

A switching converter comprises an input terminal for receiving an input voltage, an output terminal for providing an output voltage, an input switching circuit, an energy storage circuit having a capacitor, and a pre-charge circuit. The input switching circuit has a first switch and a second switch coupled in series to form a switch node. The energy storage circuit has a capacitor coupled to the switch node. The pre-charge circuit is coupled between the input terminal and the switch node, having a Zener diode and a resistor coupled in series. A cathode of the Zener diode is coupled to the input terminal. The pre-charge circuit charges the capacitor during startup of the switching converter and stops charging the capacitor based on the input voltage.

### CROSS-REFERENCE TO RELATED APPLICATIONS

This application claims the benefit of CN application 202410666746.X, filed on May 27, 2024, and incorporated herein by reference.

### BACKGROUND OF THE INVENTION

### 1. Field of the Invention

The present invention generally relates to electronic circuits, and more particularly but not exclusively relates to switching converters.

### 2. Description of Related Art

In some applications which pursue high energy conversion efficiency, high power density and small size, switching converters use capacitors as energy storage components for energy transmission and voltage conversion.

Typical topologies include switched capacitor converters (SCC), etc. In some applications, magnetic elements can be further introduced into the topology of SCC to form switched tank converters (STC), etc., which further improves efficiency and power density, so that it can provide a higher voltage conversion ratio.

However, during start-up of this type of switching converters, an initial voltage across the capacitor is zero or much lower than that in a steady state. As a result, some of the switches suffer from high voltage stress during start-up. Especially, the switches close to the input terminal suffer from a voltage which is much higher than that in the steady state. Therefore, we have to choose switches with a higher voltage rating, which will increase the cost of the switching converter and cause waste of performance.

### SUMMARY OF THE INVENTION

It is an object of the present invention to provide a switching converter and a pre-charge method of the switching converter.

Embodiments of the present invention are directed to a switching converter comprising input terminal, an output terminal, an input switching circuit, an output switching circuit, a first capacitor, a second capacitor, a third capacitor, and a pre-charge circuit. The input terminal is capable of receiving an input voltage and the output terminal is capable of providing an output voltage. The input switching circuit comprises a first switch, a second switch, a third switch, and a fourth switch, and each of the first switch, the second switch, the third switch, and the fourth switch has a first terminal and a second terminal. The first terminal of the first switch is coupled to the input terminal, the second terminal of the fourth switch is coupled to the output terminal, the second terminal of the first switch is coupled to the first terminal of the second switch to form a first switch node, the second terminal of the second switch is coupled to the first terminal of the third switch to form a second switch node, and the second terminal of the third switch is coupled to the first terminal of the fourth switch to form a third switch node. The output switching circuit is coupled to the output terminal and the input switching circuit, wherein the output switching circuit comprises at least one switch. The first capacitor coupled between the first switch node and the output switching circuit. The second capacitor is coupled between the second switch node and the output switching circuit. The third capacitor is coupled between the third switch node and the output switching circuit. The pre-charge circuit is coupled to the input terminal and at least one of the first switch node, the second switch node, and the third switch node. The pre-charge circuit comprises a first Zener diode and a first resistor coupled in series, the first Zener diode having a cathode and an anode, and the cathode of the first Zener diode is coupled to the input terminal.

Embodiments of the present invention are directed to a switching converter comprising an input terminal, an output terminal, a first switch, a second switch, a first capacitor, a first magnetic element, a second magnetic element, an output switching circuit, and a pre-charge circuit. The input terminal is capable of receiving an input voltage and the output terminal is capable of providing an output voltage. Each of the first switch and the second switch has a first terminal and a second terminal, wherein the first terminal of the first switch is coupled to the input terminal, and the second terminal of the first switch is coupled to the first terminal of the second switch to form a first switch node. Each of the first magnetic element and the second magnetic element has a first end and a second end. The first end of the first magnetic element is coupled to the second terminal of the second switch, the first end of the second magnetic element is coupled to the second end of the first capacitor, and the second end of the first magnetic element and the second end of the second magnetic element are coupled to the output terminal. The output switching circuit comprises a third switch and a fourth switch, wherein the third switch is coupled between the second terminal of the second switch and a reference ground, and the fourth switch is coupled between the second end of the first capacitor and the reference ground. The pre-charge circuit is coupled between the input terminal and the second terminal of the first switch. The pre-charge circuit comprises a first Zener diode and a first resistor coupled in series, the first Zener diode having a cathode and an anode, and the cathode of the first Zener diode is coupled to the input terminal.

Embodiments of the present invention are directed to a switching converter comprising an input terminal, an output terminal, an input switching circuit, an energy storage circuit, and a pre-charge circuit. The input terminal is capable of receiving an input voltage and the output terminal is capable of providing an output voltage. The input switching circuit comprises a first switch and a second switch coupled in series to form a first switch node. The energy storage circuit comprises a first capacitor coupled to the first switch node. The pre-charge circuit is coupled between the input terminal and the first switch node. The pre-charge circuit comprises a first Zener diode and a first resistor coupled in series, the first Zener diode having a cathode and an anode, and the cathode of the first Zener diode is coupled to the input terminal. The pre-charge circuit is configured to charge the first capacitor during startup of the switching converter and to stop charging the first capacitor based on the input voltage.

These and other features of the present invention will be readily apparent to persons of ordinary skill in the art upon reading the entirety of this disclosure, which includes the accompanying drawings and claims.

### BRIEF DESCRIPTION OF THE DRAWINGS

The present invention can be further understood with reference to following detailed description and appended drawings, wherein like components are provided with like reference numerals. These drawings are only for illustration purpose, thus may only show part of the devices and are not necessarily drawn to scale.

FIG. 1 schematically illustrates a switching converter 100 in prior art.

FIG. 2 schematically illustrates a switching converter 200 in accordance with an embodiment of the present invention.

FIG. 3 schematically illustrates a switching converter 300 in accordance with an embodiment of the present invention.

FIG. 4 schematically illustrates a switching converter 400 in accordance with an embodiment of the present invention.

FIG. 5 shows waveforms 500 of the switching converter 400 shown in FIG. 4 in accordance with an embodiment of the present invention.

FIG. 6 schematically illustrates a switching converter 600 in accordance with an embodiment of the present invention.

FIG. 7 schematically illustrates a switching converter 700 in accordance with an embodiment of the present invention.

FIG. 8 schematically illustrates a switching converter 800 in accordance with an embodiment of the present invention.

FIG. 9 schematically illustrates a switching converter 900 in accordance with an embodiment of the present invention.

FIG. 10 illustrates a pre-charge method 1000 of a switching converter in accordance with an embodiment of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one with ordinary skill in the art that the present invention may be practiced without these specific details. In other instances, well-known methods, procedures, components, and circuits have not been described in detail so as not to unnecessarily obscure aspects of the present invention.

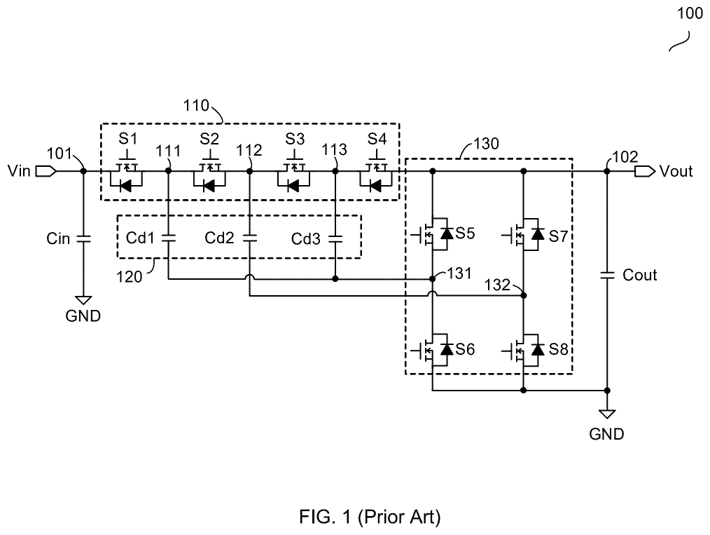

FIG. 1 schematically illustrates a switching converter 100 in prior art. As shown in FIG. 1, the switching converter 100 receives an input voltage Vin at an input terminal 101 and provides an output voltage Vout at an output terminal 102. The switching converter 100 has an input switching circuit 110, an energy storage circuit 120, and an output switching circuit 130. The input switching circuit 110 is coupled between the input terminal 101 and the output terminal 102. The input switching circuit 110 has switches S1-S4 coupled in series. Each of the switches S1-S4 has a first terminal and a second terminal. The first terminal of the switch S1 is coupled to the input terminal 101 of the switching converter 100, and the second terminal of the switch S4 is coupled to the output terminal 102 of the switching converter 100. The second terminal of the switch S1 is coupled to the first terminal of the switch S2 to form a switch node 111, the second terminal of the switch S2 is coupled to the first terminal of the switch S3 to form a switch node 112, and the second terminal of the switch S3 is coupled to the first terminal of the switch S4 to form a switch node 113. In the example of FIG. 1, the energy storage circuit 120 has capacitors Cd1, Cd2, and Cd3, and each of the capacitors Cd1-Cd3 has a first terminal and a second terminal. The first terminal of the capacitor Cd1 is coupled to the switch node 111, the first terminal of the capacitor Cd2 is coupled to the switch node 112, and the first terminal of the capacitor Cd3 is coupled to the switch node 113. The output switching circuit 130 is coupled to the output terminal 102 of the switching converter 100 to provide the output voltage Vout. In the example of FIG. 1, the output switching circuit 130 has two bridge arms formed by switches S5-S8, wherein the two bridge arms are coupled in parallel between the output terminal 102 of the switching converter 100 and the reference ground GND, and the two bridge arms have a bridge node 131 and a bridge node 132 respectively. Specifically, the switches S5 and S6 are coupled in series between the output terminal 102 and the reference ground GND, the switches S7 and S8 are coupled in series between the output terminal 102 and the reference ground GND, a common node of the switches S5 and S6 is configured as the bridge node 131, and a common node of the switches S7 and S8 is configured as the bridge node 132. As shown in FIG. 1, the output switching circuit 130 is coupled to the energy storage circuit 120. In the example of FIG. 1, the second terminal of the capacitor Cd1 and the second terminal of the capacitor Cd3 are coupled to the bridge node 131, and the second terminal of the capacitor Cd2 is coupled to the bridge node 132.

The switching converter 100 shown in FIG. 1 is described taking a switched capacitor converter (SCC) as an example, and the capacitors Cd1-Cd3 are flying capacitors. The capacitors Cd1-Cd3 are charged and discharged by turning on and off the switches S1-S8 of the input switching circuit 110 and the output switching circuit 130, thereby realizing energy transmission and voltage conversion. The switching converter 100 has a voltage conversion ratio of 4:1. In a steady state, a maximum voltage stress Vdsmax1 across the switch S1 is equal to the output voltage Vout, and a maximum voltage stress Vdsmax2 across the switch S2 is equal to twice the output voltage Vout. In one example, the input voltage Vin is 60V and the output voltage Vout is 15V in a steady state, then the maximum voltage stress Vdsmax1 of the switch S1 in the steady state is 15V, and the maximum voltage stress Vdsmax2 of the switch S2 is 30V. However, during a startup of the switching converter 100, since there is no initial charge stored in the flying capacitors Cd1-Cd3, the voltage Vds1 across the switch S1 increases with the increase of the input voltage Vin. When the input voltage Vin reaches 60V, the voltage Vds1 across the switch S1 also reaches a maximum value (about 60V), that is, during the startup of the switching converter 100, the maximum voltage stress Vdsmax1 of the switch S1 reaches about 60V. If a controller (not shown in FIG. 1) starts to control the on and off of the switches S1-S8 at this time, the maximum voltage stress Vdsmax2 of the switch S2 will also reach a level close to 60V before the switching converter 100 enters the steady state.

The above characteristics of the switching converter 100 during startup cause a great restriction in selection of the switches near the input terminal 101 (e.g., the switches S1 and S2 in FIG. 1). For example, when the input voltage Vin is 60V and the output voltage Vout is 15V, although the voltage across the switch S1 and the voltage across the switch S2 in the steady state are both much lower than 60V, it is still necessary to select switches with a voltage rating higher than 60V, which results in an increase of loss and cost of the switching converter 100. Although FIG. 1 only takes SCC as an example, one with ordinary skill in the art should understand that other switching converters using at least one capacitor for energy conversion have the same problem. Therefore, the embodiments of the present invention propose a switching converter with pre-charge circuit which requires no external control. The pre-charge circuit pre-charges the at least one capacitor of the switching converter during the startup of the switching converter and automatically stops charging the at least one capacitor based on the input voltage, thereby reducing the voltage stress of the switches near the input terminal during start-up.

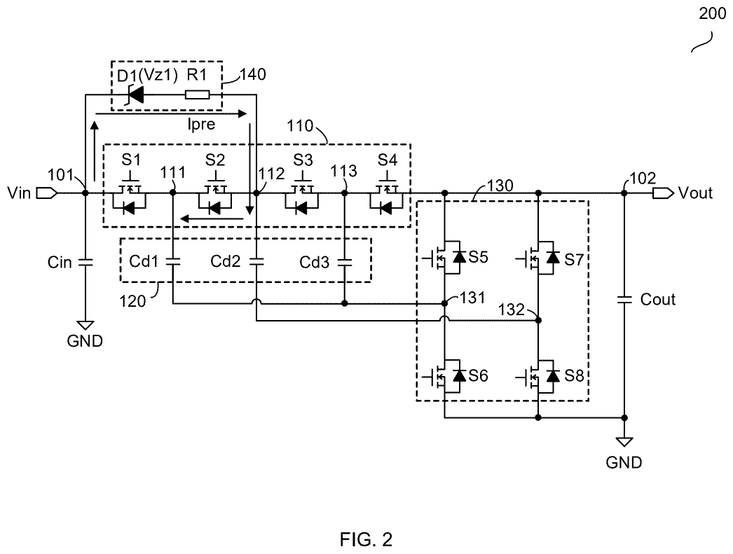

FIG. 2 schematically illustrates a switching converter 200 in accordance with an embodiment of the present invention. As shown in FIG. 2, the switching converter 100 receives the input voltage Vin at the input terminal 101 and provides an output voltage Vout to a load (not shown in FIG. 2) at the output terminal 102. The switching converter 200 has the input switching circuit 110, the energy storage circuit 120, and the output switching circuit 130. The circuit structure and connection of the input switching circuit 110, the energy storage circuit 120, and the output switching circuit 130 are the same with the switching converter 100, forming a SCC. One with ordinary skill in the art should understand that in the embodiments of the present invention, each of the switches S1-S8 may be a controllable switch comprising a metal-oxide-semiconductor field-effect transistor (MOSFET), a junction field-effect transistor (JFET), a bipolar junction transistor (BJT), a super junction transistor (SJT), or an insulate-gate bipolar transistor (IGBT), etc. The switching converter 200 is different from the switching converter 100 for further having a pre-charge circuit 140. The pre-charge circuit 140 is coupled between the input terminal 101 of the switching converter 200 and at least one of the switch nodes 111-113, that is, the pre-charge circuit 140 has a first terminal and a second terminal, the first terminal of the pre-charge circuit 140 is coupled to the input terminal 101 of the switching converter 200, and the second terminal of the pre-charge circuit 140 is coupled to at least one of the capacitors Cd1-Cd3. The pre-charge circuit 140 charges at least one of the capacitors Cd1-Cd3 during start-up of the switching converter 200, and automatically stops charging the corresponding capacitor according to the input voltage Vin. For example, after the input voltage Vin becomes stable, the pre-charge circuit 140 automatically stops charging the corresponding capacitor without external control. In the embodiment of FIG. 2, the pre-charge circuit 140 has a Zener diode D1 and a resistor R1 coupled in series between the input terminal 101 and the switch node 112. The Zener diode D1 has a cathode and an anode, and the cathode of the Zener diode D1 is coupled to the input terminal 101 of the switching converter 200. One with ordinary skill in the art should appreciate that the pre-charge circuit 140 may also be coupled between the input terminal 101 and the switch node 111, or coupled between the input terminal 101 and the switch node 113. It is noted that in the embodiments of the present invention, when an component is “connected to” or “coupled to” the other element, it means that the component is directly connected to or coupled to the other element, or indirectly connected to or coupled to the other component via another element, e.g., via resistors, capacitors, inductors, or switches, etc.

Arrows in FIG. 2 schematically illustrate a pre-charging path of the switching converter 200, i.e., a current flowing path in the pre-charging circuit 140 when pre-charging the at least one of the capacitors Cd1-Cd3. In the embodiment of FIG. 2, the Zener diode D1 has a Zener voltage Vz1. As shown by the arrows in FIG. 2, during start-up of the switching converter 200, the input voltage Vin keeps increasing from a zero voltage. When the voltage across the Zener diode D1 reaches its Zener voltage Vz1, Zener breakdown happens to the Zener diode D1, and the input voltage Vin starts to charge the capacitor Cd2 by a pre-charging current Ipre generated by the pre-charging circuit 140, and a voltage at the switch node 112 increases. In one embodiment, the switches S1-S8 are MOSFETs with body diodes, and the voltage at the switch node 112 increases to turn on the body diode of the switch S2, so that a voltage at the switch node 111 increases, thereby further charging the capacitor Cd1.

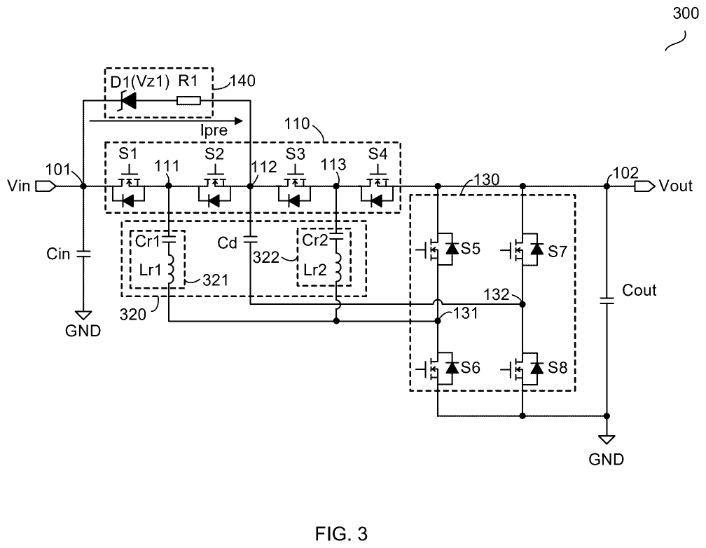

FIG. 3 schematically illustrates a switching converter 300 in accordance with an embodiment of the present invention. As shown in FIG. 3, the switching converter 300 receives the input voltage Vin at the input terminal 101 and provides the output voltage Vout at the output terminal 102. The switching converter 300 has the input switching circuit 110, an energy storage circuit 320, the output switching circuit 130, and the pre-charge circuit 140. The circuit structures and connections of the input switching circuit 110, the output switching circuit 130, and the pre-charge circuit 140 are consistent with those of the switching converter 200. The switching converter 300 is different from the switching converter 200 in that the energy storage circuit 320 has a resonant tank circuit 321 coupled between the switch node 111 and the bridge node 131, a resonant tank circuit 322 coupled between the switch node 113 and the bridge node 131, and a capacitor Cd coupled between the switch node 112 and the bridge node 132. The resonant tank circuit 321 has a capacitor Cr1 and an inductor Lr1 coupled in series, and the resonant tank circuit 322 has a capacitor Cr2 and an inductor Lr2 coupled in series. Compared with the switching converter 200, the switching converter 300 shown in FIG. 3 further forms a switched tank converter (STC) by introducing inductors Lr1 and Lr2 to the energy storage circuit 320. In the embodiment shown in FIG. 3, the pre-charging circuit 140 pre-charges the capacitor Cd and the capacitor Cr1 during start-up of the switching converter 300. The flowing path of the pre-charging current Ipre of the switching converter 300 is similar to that of the switching converter 200, which is not illustrated here for brevity.

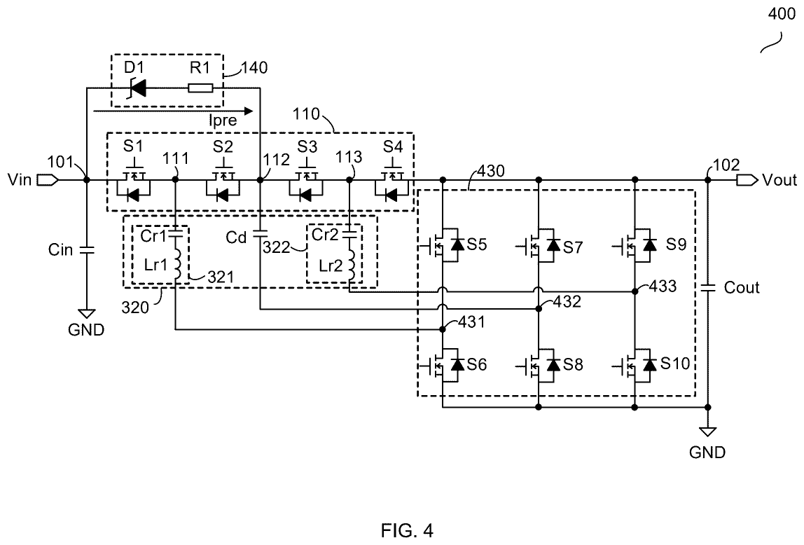

FIG. 4 schematically illustrates a switching converter 400 in accordance with an embodiment of the present invention. Similar to the switching converter 300, the switching converter 400 is also a STC. As shown in FIG. 4, the switching converter 400 receives the input voltage Vin at the input terminal 101 and provides the output voltage Vout at the output terminal 102. The switching converter 400 has the input switching circuit 110, the energy storage circuit 320, an output switching circuit 430, and the pre-charge circuit 140. The circuit structures and connections of the input switching circuit 110, the energy storage circuit 320, and the pre-charge circuit 140 are consistent with those of the switching converter 300. The switching converter 400 is different from the switching converter 300 in that the output switching circuit 430 has three bridge arms formed by switches S5-S10. The three bridge arms are coupled in parallel between the output terminal 102 and the reference ground GND of the switching converter 400, and have bridge nodes 431, 432 and 433 respectively. In the embodiment shown in FIG. 4, the resonant tank circuit 321 is coupled between the switch node 111 and the bridge node 431, the capacitor Cd is coupled between the switch node 112 and the bridge node 432, and the resonant tank circuit 322 is coupled between the switch node 113 and the bridge node 433. One with ordinary skill in the art should understand that in the embodiments of the present invention, each of the switches S1-S10 may be a controllable switch comprising a MOSFET, JFET, BJT, SJT, or IGBT, etc.

Similar to the switching converter 300, in the embodiment of FIG. 4, the pre-charging circuit 140 pre-charges the capacitor Cd and the capacitor Cr1 during start-up of the switching converter 400. When start-up is completed and the switching converter 400 enters the steady state, there should be no current flows through the pre-charging circuit 140, that is, the voltage between the input terminal 101 and the switch node 112 in the steady state is smaller than the Zener voltage Vz1 of the Zener diode D1, so that the Zener diode D1 does not break down in the steady state. For example, when the input voltage Vin is 60V and the output voltage Vout is 15V in the steady state, a maximum voltage between the input terminal 101 and the switch node 112 is 30V, and it is necessary to select a Zener diode D1 with the Zener voltage Vz1 larger than 30V (for example: Vz1=33V). In the pre-charging circuit 140, the resistor R1 works to adjust the pre-charging current Ipre. When the resistor R1 is small, the pre-charging current Ipre is large, and the capacitors Cr1 and Cd are charged rapidly. When the resistor R1 is large, the pre-charging current Ipre is small, which avoids excessive heat produced by the Zener diode D1. In one embodiment, a resistance value of the resistor R1 may be in a range of 10-200. The embodiment of FIG. 4 is illustrated by taking a STC converter as an example, one with ordinary skill in the art should understand that the energy storage circuit 320 of the switching converter 400 may also be replaced by the energy storage circuit 120 shown in FIG. 2 to form a SCC.

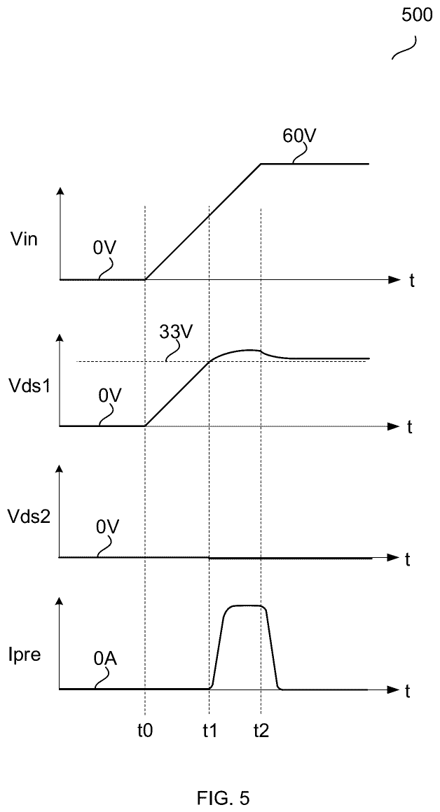

FIG. 5 shows waveforms 500 of the switching converter 400 shown in FIG. 4 in accordance with an embodiment of the present invention. The waveforms 500 illustrate a pre-charging process of the switching converter 400. FIG. 5 shows the waveforms of the input voltage Vin, the voltage Vds1 across the switch S1, the voltage Vds2 across the switch S2, and the pre-charge current Ipre of the switching converter 400 from top to bottom. The embodiment of FIG. 5 is illustrated with an example wherein the input voltage Vin is 60V in the steady state, the Zener voltage Vz1 of the Zener diode D1 is 33V, and the resistor R1 is 100. However, one with ordinary skill in the art should appreciate that the input voltage Vin in the steady state, the Zener voltage Vz1 of the Zener diode D1, and the resistor R1 can also be any other suitable values. As shown in FIG. 5, at a time t0, the input voltage Vin starts to increase from 0V. Since the voltage at the switch node 111 is still 0V, the voltage Vds1 across the switch S1 also starts to increase from 0V. At a time t1, the Zener breakdown happens to the Zener diode D1 because the voltage across the Zener diode D1 reaches its Zener voltage Vz. The voltage Vds1 across the switch S1 reaches 33V, and the pre-charging circuit 140 generates a pre-charging current Ipre to charge the capacitor Cd. Then the body diode of the switch S2 is turned on, and the pre-charging current Ipre flows through the body diode of the switch S2 to further charge the capacitor Cr1. Therefore, the voltage Vds2 across the switch S2 slightly decreases to be approximately equal to a negative value of a forward voltage drop of the body diode of the switch S2 (for example, Vds2=−2V). After the time t1, the input voltage Vin continues to increase, and the body diode of the switch S2 remains on. Therefore, the voltage Vds2 across the switch S2 remains unchanged. Since the voltage across the resistor R1 is changed, the voltage Vds1 across the switch S1 continues to increase slowly. At a time t2, the input voltage Vin reaches 60V and then remains unchanged, and the pre-charging current Ipre decreases to OA, that is, the pre-charge circuit 140 stops charging the capacitor Cd and the capacitor Cr1. The voltage Vds1 across the switch S1 reaches a maximum value of about 35V between the time t1 and the time t2, and the pre-charging current Ipre also reaches a maximum value between the time t1 and the time t2. After the time t2, the resistor R1 and the capacitor Cd are in a RC discharge process, the voltage Vds1 across the switch S1 slightly decreases and gradually reaches stabilization.

At a time after the time t2 (not marked in FIG. 5), the switching converter 400 enters the steady state wherein the switches S1-S10 are turned on and off by the controller. The maximum voltage stress Vdsmax2 of the switch S2 is around 30V in the steady state, and the maximum voltage stress Vdsmax1 of the switch S1 is around 15V in the steady state. Therefore, the switches S1 and S2 may have a voltage rating of 40V. However, the voltage rating of the switches S1 and S2 must be higher than 60V if the pre-charge circuit 140 is not included in the switching converter 400. The embodiments of the present invention reduce the voltage stress of the switches close to the input terminal during start-up of the switching converter requiring no external control, thereby reducing waste of performance and the circuit cost of the switching converter.

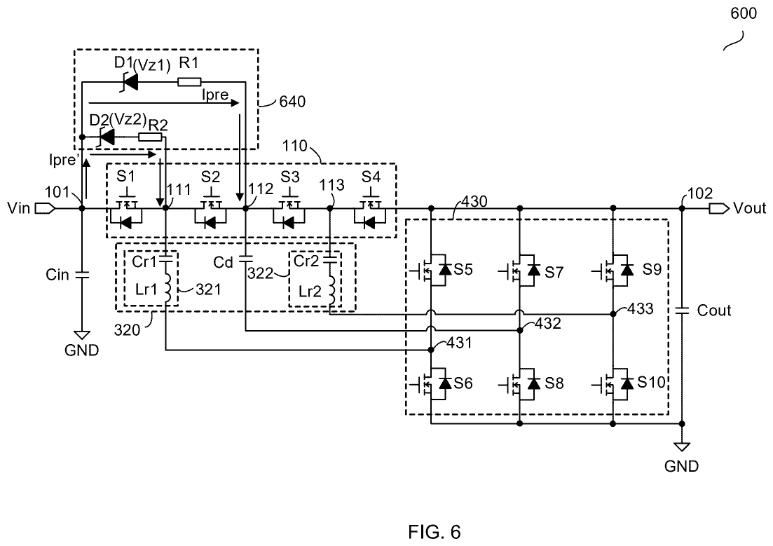

FIG. 6 schematically illustrates a switching converter 600 in accordance with an embodiment of the present invention. The switching converter 600 is a STC similar to the switching converter 400 shown in FIG. 4. As shown in FIG. 6, the switching converter 600 receives the input voltage Vin at the input terminal 101 and provides the output voltage Vout at the output terminal 102. The switching converter 600 has the input switching circuit 110, the energy storage circuit 320, the output switching circuit 430, and a pre-charge circuit 640. The circuit structures and connections of the input switching circuit 110, the energy storage circuit 320, and the output switching circuit 430 are consistent with those of the switching converter 400. The switching converter 600 is different from the switching converter 400 in that the pre-charge circuit 640 further has a Zener diode D2 and a resistor R2 coupled in series between the input terminal 101 and the switch node 111 compared with the pre-charge circuit 140. In the embodiment of FIG. 6, the Zener diode D2 has a cathode and an anode, and the cathode of the Zener diode D2 is coupled to the input terminal 101 of the switching converter 600.

Arrows in FIG. 6 schematically illustrate a pre-charging path of the switching converter 600, i.e., a current flowing path in the pre-charging circuit 640 when pre-charging at least one of the capacitors Cr1, Cd, and Cr2 of the energy storage circuit 320. In the embodiment of FIG. 6, the Zener diode D2 has a Zener voltage Vz2 which is smaller than the Zener voltage Vz1 of the Zener diode D1. As shown by the arrows in FIG. 6, during start-up of the switching converter 600, the input voltage Vin increases and Zener breakdown happens to the Zener diode D2 with a voltage across the Zener diode D2 reaching its Zener voltage Vz2, and then a pre-charging current Ipre′ is generated to charge the capacitor Cr1 via the Zener diode D2 and the resistor R2, so that the voltage at the switch node 111 increases. When the voltage across the Zener diode D1 reaches its Zener voltage Vz1, Zener breakdown happens to the Zener diode D1, and the pre-charging current Ipre is generated to charge the capacitor Cd via the Zener diode D1 and the resistor R1, so that the voltage at the switch node 112 increases.

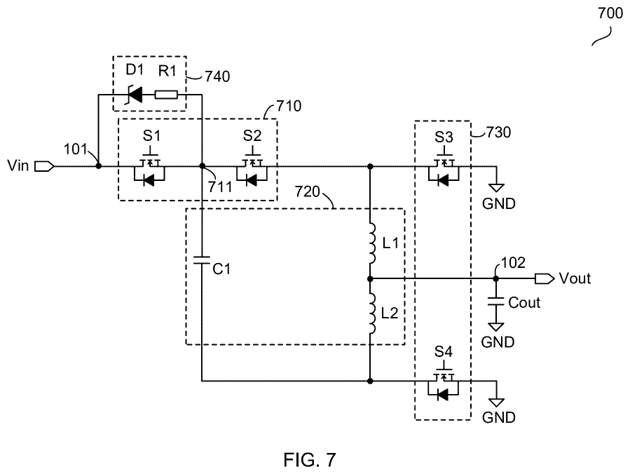

FIG. 7 schematically illustrates a switching converter 700 in accordance with an embodiment of the present invention. As shown in FIG. 7, the switching converter 700 receives the input voltage Vin at the input terminal 101 and provides the output voltage Vout at the output terminal 102. The switching converter 700 has an input switching circuit 710, an energy storage circuit 720, an output switching circuit 730, and a pre-charge circuit 740. The input switching circuit 710 is coupled between the input terminal 101 and the output terminal 102 of the switching converter 700, having switches S1 and S2 coupled in series, and the switches S1 and S2 each have a first terminal and a second terminal. The first terminal of the switch S1 is coupled to the input terminal 101 of the switching converter 700, and the second terminal of the switch S1 is coupled to the first terminal of the switch S2 to form a switch node 711. In the embodiment shown in FIG. 7, the energy storage circuit 720 has a capacitor C1, a magnetic element L1, and a magnetic element L2. The capacitor C1, the magnetic element L1, and the magnetic element L2 each have a first terminal and a second terminal. The first terminal of the capacitor C1 is coupled to the switch node 711, the first terminal of the magnetic element L2 is coupled to the second terminal of the capacitor C1, the first terminal of the magnetic element L1 is coupled to the first terminal of the switch S2, and the second terminals of the magnetic elements L1 and L2 are coupled to the output terminal 102 of the switching converter 700. In one embodiment, the magnetic elements L1 and L2 may be discrete inductance components, and in another embodiment, the magnetic elements L1 and L2 may be two windings of a transformer, or two windings electromagnetically coupled to each other in other ways. The output switching circuit 730 has switches S3 and S4, wherein the switch S3 is coupled between the second terminal of the switch S2 and the reference ground GND, and the switch S4 is coupled between the second terminal of the capacitor C1 and the reference ground GND. The pre-charge circuit 740 has the Zener diode D1 and the resistor R1 coupled in series, wherein the cathode of the Zener diode D1 is coupled to the input terminal 101 of the switching converter 700. During start-up of the switching converter 700, with the increase of the input voltage Vin, when the voltage across the Zener diode D1 reaches its Zener voltage Vz1, Zener breakdown happens to the Zener diode D1, and the input voltage Vin starts to pre-charge the capacitor C1 through the pre-charge circuit 740.

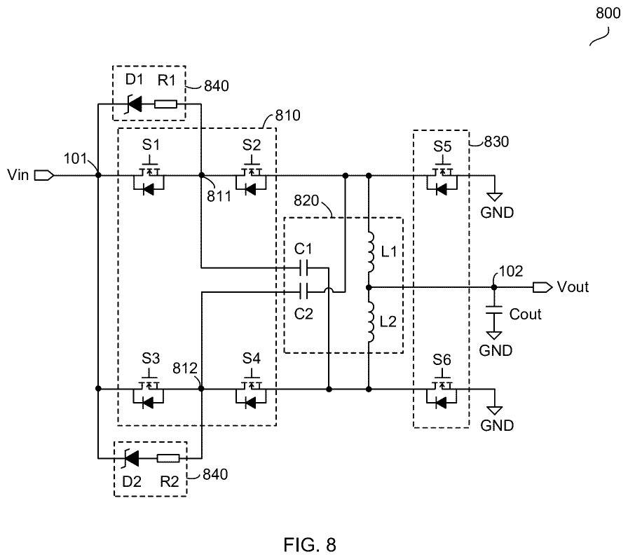

FIG. 8 schematically illustrates a switching converter 800 in accordance with an embodiment of the present invention. As shown in FIG. 8, the switching converter 800 receives the input voltage Vin at the input terminal 101 and provides the output voltage Vout at the output terminal 102. The switching converter 800 has an input switching circuit 810, an energy storage circuit 820, an output switching circuit 830, and a pre-charge circuit 840. The input switching circuit 810 is coupled between the input terminal 101 and the output terminal 102 of the switching converter 800. The input switching circuit 810 has the switches S1-S4, each of which has a first terminal and a second terminal. The switches S1 and S2 are coupled in series, the first terminal of the switch S1 is coupled to the input terminal 101 of the switching converter 800, and the second terminal of the switch S1 is coupled to the first terminal of the switch S2 to form a switch node 811. The switches S3 and S4 are coupled in series, the first terminal of the switch S3 is coupled to the input terminal 101 of the switching converter 800, and the second terminal of the switch S3 is coupled to the first terminal of the switch S4 to form a switch node 812. In the embodiment of FIG. 8, the energy storage circuit 820 has the capacitor C1, a capacitor C2, the magnetic element L1 and the magnetic element L2. The capacitor C1, the capacitor C2, the magnetic element L1 and the magnetic element L2 each have a first terminal and a second terminal. The first terminal of the capacitor C1 is coupled to the switch node 811, the first terminal of the capacitor C2 is coupled to the switch node 812, the first terminal of the magnetic element L2 is coupled to the second terminal of the capacitor C1, the first terminal of the magnetic element L1 is coupled to the second terminal of the capacitor C2, and the second terminals of the magnetic elements L1 and L2 are coupled to the output terminal 102 of the switching converter 800. The output switching circuit 830 has the switches S5 and S6, the switch S5 is coupled between the second terminal of the switch S2 and the reference ground GND, and the switch S6 is coupled between the second terminal of the switch S4 and the reference ground GND. The pre-charge circuit 840 has the Zener diode D1 and the resistor R1 coupled in series, and the Zener diode D2 and the resistor R2 coupled in series. The cathode of the Zener diode D1 is coupled to the input terminal 101 of the switching converter 800, and the Zener diode D1 has a Zener voltage Vz1. The cathode of the Zener diode D2 is coupled to the input terminal 101 of the switching converter 800, and the Zener diode D2 has a Zener voltage Vz2. During start-up of the switching converter 800, with the increase of the input voltage Vin, when the voltage across the Zener diode D1 reaches its Zener voltage Vz1, Zener breakdown happens to the Zener diode D1, and the input voltage Vin starts to charge the capacitor C1 through the Zener diode D1 and the resistor R1 coupled in series. When the voltage across the Zener diode D2 reaches its Zener voltage Vz2, Zener breakdown happens to the Zener diode D2, and the input voltage Vin starts to pre-charge the capacitor C2 through the Zener diode D2 and the resistor R2 coupled in series.

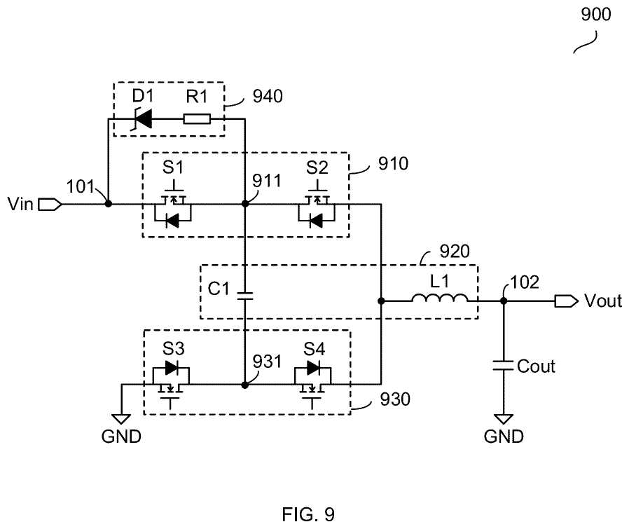

FIG. 9 schematically illustrates a switching converter 900 in accordance with an embodiment of the present invention. In the embodiment of FIG. 9, the switching converter 900 is a three-level step-down converter. As shown in FIG. 9, the switching converter 900 receives the input voltage Vin at the input terminal 101 and provides the output voltage Vout at the output terminal 102. The switching converter 900 has an input switching circuit 910, an energy storage circuit 920, an output switching circuit 930, and a pre-charge circuit 940. The input switching circuit 910 is coupled between the input terminal 101 and the output terminal 102 of the switching converter 900, having the switches S1 and S2 coupled in series. The output switching circuit 930 is coupled between the output terminal 102 of the switching converter 900 and the reference ground GND, having the switches S3 and S4 coupled in series. In the embodiment of FIG. 9, the input switching circuit 910 and the output switching circuit 930 are both coupled to the output terminal 102 of the switching converter 900 via the inductor L1. Each of the switches S1-S4 has a first terminal and a second terminal. The first terminal of the switch S1 is coupled to the input terminal 101 of the switching converter 900, and the second terminal of the switch S1 is coupled to the first terminal of the switch S2 to form a switch node 911. The first terminal of the switch S3 is coupled to the reference ground GND, and the second terminal of the switch S3 is coupled to the first terminal of the switch S4 to form a switch node 931. In the embodiment shown in FIG. 9, the energy storage circuit 920 has the capacitor C1 and the inductor L1, and the capacitor C1 and the inductor L1 each have a first terminal and a second terminal. The first terminal of the capacitor C1 is coupled to the switch node 911, and the second terminal of the capacitor C1 is coupled to the switch node 931. The first terminal of the inductor L1 is coupled to the second terminal of the switch S2 and the second terminal of the switch S4, and the second terminal of the inductor L1 is coupled to the output terminal 102 of the switching converter 900, that is, the input switching circuit 910 and the output switching circuit 930 are both coupled to the output terminal 102 of the switching converter 900 via the inductor L1. The pre-charge circuit 940 has the Zener diode D1 and the resistor R1 coupled in series, and the cathode of the Zener diode D1 is coupled to the input terminal 101 of the switching converter 900. During start-up of the switching converter 900, with the increase of the input voltage Vin, when the voltage across the Zener diode D1 reaches its Zener voltage Vz1, Zener breakdown happens to the Zener diode D1, and the input voltage Vin starts to pre-charge the capacitor C1 through the pre-charging circuit 940. Although the embodiment shown in FIG. 9 is illustrated by taking a three-level buck converter circuit as an example, one with ordinary skill in the art should understand that the pre-charge circuit 940 may also be applied to other multi-level converter circuits.

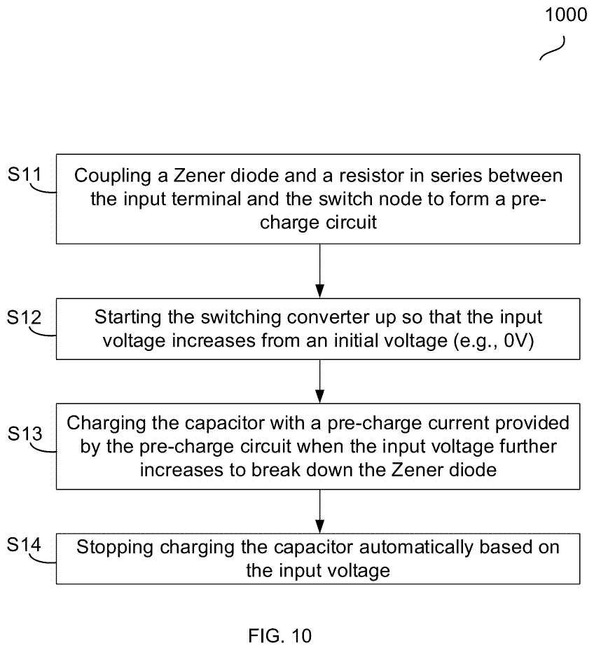

FIG. 10 illustrates a pre-charge method 1000 of a switching converter in accordance with an embodiment of the present invention. The switching converter has an input terminal for receiving an input voltage and an output terminal for providing the output voltage. The switching converter further has an input switching circuit, an energy storage circuit, and an output switching circuit. The input switching circuit is coupled between the input terminal and the output terminal of the switching converter. The input switching circuit has a first switch and a second switch, and a common node of the first switch and the second switch forms a switch node. The output switching circuit is coupled to the energy storage circuit and the output terminal of the switching converter. The output switching circuit has at least one switch. The pre-charge method 1000 comprises steps S11-S14.

In step S11, coupling a Zener Diode and a resistor in series between the input terminal and the switch node to form a pre-charge circuit. Wherein the pre-charge circuit is capable of pre-charging a capacitor of the energy storage circuit during start-up of the switching converter.

In step S12, starting the switching converter up so that the input voltage increases from an initial voltage (e.g., 0V).

In step S13, charging the capacitor with a pre-charge current provided by the pre-charge circuit when the input voltage further increases to break down the Zener diode.

In step S14, stopping charging the capacitor automatically based on the input voltage.

Note that in the pre-charge method 1000 described above, the functions indicated in the boxes can also occur in a different order than those shown in FIG. 10. For example, two boxes presented one after another can actually be executed essentially at the same time, or sometimes in reverse order, depending on the specific functionality involved.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A switching converter, comprising:
an input terminal, capable of receiving an input voltage;
an output terminal, capable of providing an output voltage;
an input switching circuit comprising a first switch, a second switch, a third switch, and a fourth switch, each of the first switch, the second switch, the third switch, and the fourth switch having a first terminal and a second terminal, wherein the first terminal of the first switch is coupled to the input terminal, the second terminal of the fourth switch is coupled to the output terminal, the second terminal of the first switch is coupled to the first terminal of the second switch to form a first switch node, the second terminal of the second switch is coupled to the first terminal of the third switch to form a second switch node, and the second terminal of the third switch is coupled to the first terminal of the fourth switch to form a third switch node;
an output switching circuit, coupled to the output terminal and the input switching circuit, wherein the output switching circuit comprises at least one switch;
a first capacitor coupled between the first switch node and the output switching circuit;
a second capacitor coupled between the second switch node and the output switching circuit;
a third capacitor, coupled between the third switch node and the output switching circuit; and
a pre-charge circuit, coupled to the input terminal and at least one of the first switch node, the second switch node, and the third switch node; wherein
the pre-charge circuit comprises a first Zener diode and a first resistor coupled in series, the first Zener diode having a cathode and an anode, and the cathode of the first Zener diode is coupled to the input terminal.

2. The switching converter of claim 1, wherein the first Zener diode and the first resistor are coupled in series between the input terminal and the second switch node.

3. The switching converter of claim 2, wherein the pre-charge circuit further comprises a second Zener diode and a second resistor coupled in series between the input terminal and the first switch node, wherein:
the second Zener diode has a cathode and an anode, and the cathode of the second Zener diode is coupled to the input terminal.

4. The switching converter of claim 1, wherein the output switching converter further comprises:
a first bridge arm coupled between the output terminal and a reference ground, the first bridge arm having a first bridge node; and
a second bridge arm coupled between the output terminal and the reference ground, the second bridge arm having a second bridge node; wherein
the first capacitor is coupled between the first switch node and the first bridge node, the second capacitor is coupled between the second switch node and the second bridge node, and the third capacitor is coupled between the third switch node and the first bridge node.

5. The switching converter of claim 1, wherein the output switching converter further comprises:
a first bridge arm, a second bridge arm and a third bridge arm coupled in parallel between the output terminal a reference ground, wherein the first bridge arm has a first bridge node, the second bridge arm has a second bridge node, and the third bridge arm has a third bridge node; wherein
the first capacitor is coupled between the first switch node and the first bridge node, the second capacitor is coupled between the second switch node and the second bridge node, and the third capacitor is coupled between the third switch node and the third bridge node.

6. The switching converter of claim 5, further comprising:
a first inductor, wherein the first inductor and the first capacitor are coupled in series between the first switch node and the first bridge node to form a first resonant tank circuit; and
a second inductor, wherein the second inductor and the third capacitor are coupled in series between the third switch node and the third bridge node to form a second resonant tank circuit.

7. A switching converter, comprising:
an input terminal, capable of receiving an input voltage;
an output terminal, capable of providing an output voltage;
a first switch and a second switch, each of the first switch and the second switch having a first terminal and a second terminal, wherein the first terminal of the first switch is coupled to the input terminal, and the second terminal of the first switch is coupled to the first terminal of the second switch to form a first switch node;
a first capacitor having a first end and a second end, wherein the first end of the first capacitor is coupled to the first switch node;
a first magnetic element and a second magnetic element, each of the first magnetic element and the second magnetic element having a first end and a second end, the first end of the first magnetic element is coupled to the second terminal of the second switch, the first end of the second magnetic element is coupled to the second end of the first capacitor, and the second end of the first magnetic element and the second end of the second magnetic element are coupled to the output terminal;
an output switching circuit comprising a third switch and a fourth switch, wherein the third switch is coupled between the second terminal of the second switch and a reference ground, and the fourth switch is coupled between the second end of the first capacitor and the reference ground; and
a pre-charge circuit, coupled between the input terminal and the second terminal of the first switch; wherein
the pre-charge circuit comprises a first Zener diode and a first resistor coupled in series, the first Zener diode having a cathode and an anode, and the cathode of the first Zener diode is coupled to the input terminal.

8. The switching converter of claim 7, further comprising:
a fifth switch and a sixth switch, each of the fifth switch and the sixth switch having a first terminal and a second terminal, wherein the first terminal of the fifth switch is coupled to the input terminal, and the second terminal of the fifth switch is coupled to the first terminal of the sixth switch to form a second switch node; and
a second capacitor, coupled between the second switch node and the first end of the first magnetic element; wherein
the pre-charge circuit further comprises a second Zener diode and a second resistor coupled in series between the input terminal and the second terminal of the fifth switch; and wherein
the second Zener diode has a cathode and an anode, and the cathode of the second Zener diode is coupled to the input terminal.

9. A switching converter, comprising:
an input terminal, capable of receiving an input voltage;
an output terminal, capable of providing an output voltage;
an input switching circuit comprising a first switch and a second switch coupled in series to form a first switch node;
an energy storage circuit comprising a first capacitor coupled to the first switch node; and
a pre-charge circuit, coupled between the input terminal and the first switch node, wherein the pre-charge circuit comprises a first Zener diode and a first resistor coupled in series, the first Zener diode having a cathode and an anode, and the cathode of the first Zener diode is coupled to the input terminal; wherein
the pre-charge circuit is configured to charge the first capacitor during startup of the switching converter, and is further configured to stop charging the first capacitor based on the input voltage.

10. The switching converter of claim 9, wherein:
the input switching circuit is coupled between the input terminal and the output terminal, and the input switching circuit further comprises a third switch and a fourth switch, each of the first switch, the second switch, the third switch and the fourth switch comprises a first terminal and a second terminal, wherein the first terminal of the third switch is coupled to the input terminal, the second terminal of the third switch is coupled to the first terminal of the first switch to form a second switch node, the second terminal of the first switch is coupled to the first terminal of the second switch to form a first switch node, the second terminal of the second switch is coupled to the first terminal of the fourth switch to form a third switch node, and the second terminal of the fourth switch is coupled to the output terminal; and wherein
the energy storage circuit further comprises a second capacitor and a third capacitor, wherein the second capacitor is coupled to the second switch node, and the third capacitor is coupled to the third switch node.

11. The switching converter of claim 10, further comprising an output switching circuit coupled to the energy storage circuit and the output terminal, wherein:
the energy storage circuit further comprises a first inductor and a second inductor; and wherein
the first inductor and the second capacitor are coupled in series between the second switch node and the output switching circuit, and the second inductor and the third capacitor are coupled in series between the third switch node and the output switching circuit.

12. The switching converter of claim 10, further comprising:
a first bridge arm coupled between the output terminal and a reference ground, the first bridge arm having a first bridge node; and
a second bridge arm coupled between the output terminal and the reference ground, the second bridge arm having a second bridge node; wherein
the first capacitor is coupled between the first switch node and the second bridge node, the second capacitor is coupled between the second switch node and the first bridge node, and the third capacitor is coupled between the third switch node and the first bridge node.

13. The switching converter of claim 10, further comprising:
a first bridge arm, a second bridge arm and a third bridge arm coupled in parallel between the output terminal a reference ground, wherein the first bridge arm has a first bridge node, the second bridge arm has a second bridge node, and the third bridge arm has a third bridge node; wherein
the first capacitor is coupled between the first switch node and the second bridge node, the second capacitor is coupled between the second switch node and the first bridge node, and the third capacitor is coupled between the third switch node and the third bridge node.

14. The switching converter of claim 10, wherein the pre-charge circuit further comprises a second Zener diode and a second resistor coupled in series between the input terminal and the second switch node, wherein:
the second Zener diode has a cathode and an anode, and the cathode of the second Zener diode is coupled to the input terminal.

15. The switching converter of claim 9, further comprising an output switching circuit formed by a third switch and a fourth switch, wherein:
the energy storage circuit further comprises a first magnetic element and a second magnetic element, each of the first magnetic element and the second magnetic element having a first end and a second end, the first end of the first magnetic element is coupled to the second terminal of the second switch, the first end of the second magnetic element is coupled to the second end of the first capacitor, and the second end of the first magnetic element and the second end of the second magnetic element are coupled to the output terminal; and wherein
the third switch is coupled between the second terminal of the second switch and a reference ground, and the fourth switch is coupled between the second end of the first capacitor and the reference ground.

16. The switching converter of claim 15, wherein:
the input switching circuit further comprises a fifth switch and a sixth switch, each of the fifth switch and the sixth switch having a first terminal and a second terminal, wherein the first terminal of the fifth switch is coupled to the input terminal, and the second terminal of the fifth switch is coupled to the first terminal of the sixth switch to form a second switch node; and
a second pre-charge circuit, coupled between the input terminal and the second switch node, wherein the second pre-charge circuit comprises a second Zener diode and a second resistor coupled in series; wherein
the second Zener diode has a cathode and an anode, and the cathode of the second Zener diode is coupled to the input terminal.

17. The switching converter of claim 9, further comprising an output switching circuit having a third switch and a fourth switch, wherein:
each of the first switch, the second switch, the third switch, and the fourth switch has a first terminal and a second terminal, the first terminal of the first switch is coupled to the input terminal of the switching converter, the second terminal of the first switch and the first terminal of the second switch are coupled to form the first switch node, the first terminal of the third switch is coupled to a reference ground, and the second terminal of the third switch and the first terminal of the fourth switch are coupled to form a second switch node; and wherein
the output switching circuit is coupled to the energy storage circuit and the output terminal, and the energy storage circuit further comprises an inductor coupled between the second terminal of the second switch and the output terminal.
